(19) United States
(12) Patent Application Publication
(10) Pub. No.: US 2022/0030787 A1
(43) Pub. Date: Feb. 3, 2022

(54) Spiral Tower Growing Systems and Methods

(71) Applicant: Mobius Farm, LLC, Norristown, PA (US)

(72) Inventors: Joseph M. Wolf, Norristown, PA (US); Stephen F. Barker, Centerville, OH (US)

(73) Assignee: Mobius Farm, LLC, Norristown, PA (US)

(21) Appl. No.: 17/088,944

(22) Filed: Nov. 4, 2020

Related U.S. Application Data
(60) Provisional application No. 63/060,019, filed on Aug. 1, 2020.

(51) Int. Cl. A01G 31/04; A01G 7/04

(52) U.S. Cl. CPC A01G 31/045; A01G 7/045; A01G 31/042

(57) ABSTRACT

The present invention relates to a self-contained growth system that functions as a stand-alone growth system or combined with a hydroponic or aeroponic growth system for the controlled growth of plants. A Spiral Tower having an entry port for seedling or seeds embedded onto trays floating on a downward spiraling water flow provides a closed environment with optimum nutrient and growth conditions for each plant type. The Spiral

Tower is capable of germinating seedlings in a closed environment for subsequent maturation in an aeroponic or other system. As a stand-alone growth system, the Spiral Tower is capable of the continued growth of certain early life plants. Other applications as a seed to harvest system used in harvesting wheatgrass and similar plants. The system is designed for cost-effective use in restricted space and in regions not conducive for commercial plant production.

### RELATED APPLICATIONS

This application claims the benefit of U.S. Provisional Patent Application Ser. No. 63/060,019, filed Aug. 1, 2020, the disclosure of which is incorporated herein by reference.

### FIELD OF THE INVENTION

The present invention relates to a hydroponic system as a stand-alone growth system or as a germination component of a larger automatic system, such as in an aeroponic growth system for starting or finishing seedlings of all types of plants. More particularly, the invention relates to a self-contained, stand-alone system, device, and methods useful as a germination system, cloning unit, or growing plants within a closed Spiral Tower.

### BACKGROUND

There are many methods for growing plants. They range from the most ancient method of planting seeds in the ground and letting nature provide the necessary water, nutrients and light necessary for photosynthesis to more modern methods. These would include industrial agriculture methods where the seeds are still planted in the ground, but the water, nutrients and other chemicals are used to promote growth and prevent intrusion of insects and plant diseases are provided by the “farmer.” Many improvements have been made with this method to improve yields, sometimes to the detriment of the end product in quality and nutritional value.

Another method used more recently to grow plants is hydroponics. This method eliminates the soil from the process, growing the plants with the roots fully or partially immersed in water. Hydroponics requires a near horizontal means to contain the water and plants, and also a means to provide circulation of the water so that water and nutrients may be continuously added.

A third method would utilize an aeroponic system. Aeroponics systems have been described as having water and nutrient requirements with approximately 10% of the water and nutrient requirement of soil based and hydroponic methods while eliminating the requirement for insecticides and herbicides as described in US Pub No. 2018/0077884, herein referenced in its entirety. The aeroponic method is similar to hydroponics in that the soil is eliminated, but instead of sitting the roots in a horizontal body of water, the roots are suspended in the air using a variety of methods. The water with nutrients is supplied in the form of either a drip and/or a mist. This method not only greatly reduces the amount of water required; the plants are not restricted to a horizontal arrangement but can be arranged in any orientation. In one option, the plants are irrigated using a high-pressure spray providing a nutrient rich mist to the roots. There may be a single spay bar or multiple spray bars which would be located so that they could be operated intermittently, effectively misting all the roots at the same time. In the event of a power failure, water is supplied to the roots by a gravity fed drip system initiated when a power failure opens a normally open valve which had been held closed by the power.

All of the above methods are in commercial use today with the soil based methods being overwhelmingly the most prominent. However, both land and water are becoming increasingly more difficult to obtain. Likewise, the world population is growing at a rate which land based methods are finding it difficult to keep pace delivering the necessary amount of edible plants while eliminating waste.

One serious issue with these centralized methods is in the delivery of a low-priced, disease-free product to market of the harvested crops. Many crops are harvested before the plants are fully mature to allow for long delivery times. They are then either force matured using chemicals or sold “green” so they mature at the consumer's. The outcome of this is that almost 40% of the crops are lost through transportation losses and over ripening at the point of sale and/or with the consumer.

There is a critical need for a method to both grow fully mature edible plants, using a minimum amount of water and space, and then deliver them efficiently directly to the consumer with little or no loss. Prior application (US Pub No. 2018/0077884, Barker) provided a means to grow plants that were optimized for nutritional value and taste while using a minimum amount of resources. However, this process describes a Propagation Module where seeds are grown in a fixed Propagation Drawer requiring continued human monitoring while water and nutrients are circulated. Generating seedlings by this means requires significant energy for pumping water and irrigating the seeds and the need to have continued manual attention. There is also a need to provide an environmentally controlled growing system for plant cloning, or asexual reproduction. Asexual reproduction produces a genetically identical copy or copies of a parent plant. Various methods exist for plant cloning such as cuttings, divisions, offsets, bulbs, runners, grafting, layering and micropropagation. Many of these are suitable for the home gardener as well as commercial farmers and horticulturalists. Plant cloning allows a large amount of genetically identical plants to be produced from a single parent. The advantage of this genetic uniformity is that all of these plants will have the exact same genetic characteristics, which may not have been transmitted to seeds formed by sexual reproduction. Cloning plants allows for producers to grow plants that they know are resistant to devastating diseases, allowing less use of herbicides and pesticides and resulting in fewer economic losses. It is important that plants are only cloned from healthy, disease-free parents. if this is done, then they are guaranteed to be free from disease and the risk of introducing a mutation caused by the environment is reduced.

Both aeroponic and hydroponic techniques have proved very successful in carefully controlled laboratory environments. However, aeroponic and hydroponic techniques have yet to be considered feasible for mainstream production of crops or for adaptation on a wide, commercial scale. These systems do not provide for more effective control of productivity and growth efficiency relating to crops overall. Further, these prior art systems are not amenable to space optimization or cost and the advantages that are derive therein, including new market models for growing, previously unusable distribution and selling locations for a given crop or plant product. Other related challenges include providing scalable growing systems that are readily adapted to the requirements of different plants and optimizing the space and location of the growing system while increasing the production (yield), improve the product assortment available from plants, and increase the useful productive life of plants.

There is also a need to provide growing systems that are efficient and productive such that the energy costs associated with operation are justified by the output produced.

Further, there is a real need to provide systems that offer diverse and highly tailored control over plant growth and which are easy and relatively inexpensive to manufacture, install, operate and maintain.

The present system addresses these problems by providing a vertical spiral tower. It is a stand-alone, self-contained system with the ability to independently asexually clone plants, germinate seedlings for further development in a separate finishing system from seeds or utilize as a self-contained, stand-alone growing system to germinate seeds or start growth at an early period and continue to harvest. It maximizes space, resources consumed and manpower and still provides consistent, stable plants at a low cost to consumers.

### BRIEF SUMMARY OF THE INVENTION

The present invention utilizes a novel stand-alone, self-contained tower having a continuous spiral flow of water to move a collection of growing or germinating plants from an initial starting location at an entry port on the top of the tower to a collecting or harvest point along the downward flow and to provide the complete requirements of nutrients and conditions needed by the growing plants or germinating seeds (Spiral Tower). The Spiral Tower utilizes a hydroponic system design whereby the target plants whether starting as seeds or plants are affixed in trapezoidal trays designed to expose the growing plants to nutrients found in the flowing water while staying afloat on a descending spiral path that exposes them to the optimum light and other environmental conditions. The trays may have a barcode, RF tag or similar method for the system elements to tailor the processes and monitor plant development. The Spiral Tower is maintained internally at optimum conditions required for the specific plant's grow whether for the germination of seedlings, plant cloning (asexual reproduction), or in continuous plant use situation such as with the growth of wheatgrass. The Trays move at a controlled flow rate to produce seedlings at their desired growth state at a set point along the spiral. In one embodiment trays are floated on either a continuous or intermittent stream of water moving in a spiral motion from an upper entry point to a lower exit point, at which point the seeds have reached an optimum germination state to be transferred to a secondary or tertiary system to complete their growth cycle.

In addition to the nutrients, the light required for growth is artificial light in the most advantageous spectrums to include IR. This light is supplied by LED's in one embodiment. The Spiral Tower may be housed within an enclosed environment such as a building or warehouse.

In one embodiment trays with seeds are moved from the upper end of the Spiral Tower through an upper opening or port. Filtered and pH balanced water containing appropriate nutrients having optimized growing conditions flows in a downward spiral movement carrying the trays. The trays are floated in a time-dependent rate down the flowing spiral to exit through a lower opening or port at an optimum time whereby the seedlings have reached the desired growth and can either continue growing within a finishing system to complete plant growth for later harvest or, if appropriate, harvest directly from the exit port. Conditions within the system are automatically monitored and reported to allow for real-time adjustments to the conditions.

During germination the trays may be covered with a removable cover to limit light to the seeds. The placement and removal of these covers could be by manual or automated methods.

In another embodiment, the Spiral Tower is effective in early growth development of plants, unrelated to germination. Under the appropriate conditions, the Spiral Tower is suitable for most species of plants, trees, or bushes provided the growing plants can be situated on the flowing trays during their growing period. Young plants are introduced at the entry port and allowed to grow to a certain point within the Spiral Tower and either harvested from the Spiral Tower or continued growing in another system.

In another embodiment, the Spiral Tower provides a controlled environment for asexual reproducing selected plants. The stand-alone design provides an environment with reduced risk for mutation or a means to introduce targeted point mutations that may affect, for example, color or shape under certain stressful conditions.

In still another embodiment, the Spiral Tower provides the complete growing environment from initial germination to harvest. This would include plants such as, but not limited to wheatgrass. Wheatgrass can be started on trays used in the Spiral Tower. By simply cutting and repopulating the tray, the tray can be restarted in the system for continued new growth and harvest within the Spiral Tower.

### BRIEF DESCRIPTION OF THE DRAWINGS

Some embodiments of the present invention are illustrated as an example and are not limited by the figures of the accompanying drawings:

FIG. 1 depicts an automated growth center with spiral systems and conveyor.

FIG. 2 depicts two variations of a vertical belt or conveyor system in an enclosure according to various embodiments described herein.

FIG. 3 depicts several sections of a hanging wall with plant pods according to various embodiments described herein.

FIG. 4A depicts a drawing of the Spiral Tower showing the entry and exit ports and the spiral stream for floating the Seed Trays.

FIG. 4B is a representation of the spiral stream within the Spiral Tower showing a typical Carrier Tray positioned within the spiral and having a single developing embedded seed puck.

FIG. 5A representation of a carrier try having embedded pucks with seeds at various stages of plant development.

FIG. 5B depicts a close up of a Growth Disk with seeds according to various embodiments described herein.

FIG. 6 depicts a Grow Pod Holder that would be placed into a holding receptacle on any of the proposed systems to allow for easy insertion and removal of the plants according to various embodiments described herein.

FIG. 7 depicts a Grow Tile according to various embodiments described herein.

FIG. 8 depicts a Seed Tray in its Shipping Bag with plant type and growth settings according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “compromises” and/or “compromising,” when used in this specification, specify the presence of stated, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those used in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specifications and claims should be read with the understanding that such combinations are entirely within the scope of the invention and claims.

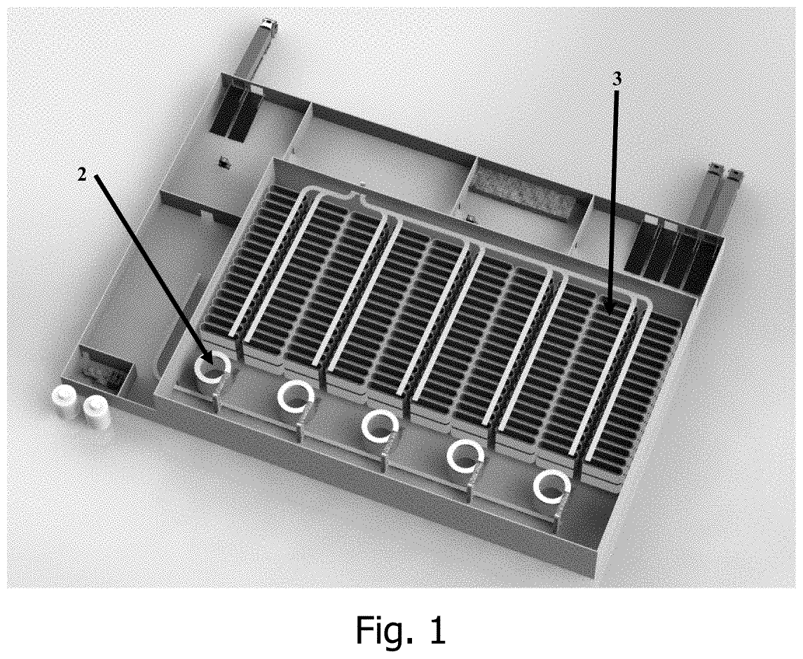

The present invention is described referencing the appended figures. One characteristic of the present invention is an enclosed environment. The enclosure provides a controlled environment such as a warehouse, building, single or multiple Spiral Towers are positioned where they are able to supply seedlings for an individual Harvest Conveyor or multiple Harvest Conveyors of a plant growing process that is designed to continually supply sufficient commercial produce in a closed system. The enclosure contains an independent germination section (Spiral Tower), a Grow/Harvest section and a Packing section. A typical closed system with a Spiral Tower, 1, a plant Grow/Harvest section, 2, and a Packing section, 3, is exemplified in FIG. 1. Seedlings from the Spiral Towers are allowed to complete their growth process in the Grow/Harvest section and finally cleaned and packaged in the Packing section. The Spiral Tower is a self-contained, stand-alone germination subsystem containing a spiral flow of filtered water which is pH balanced and containing the necessary nutrients in a continual or intermittent flow downward at a rate that allows the seeds within the seed trays to germinate seedlings. FIG. 1 shows a Spiral Tower juxtaposed to a Conveyor in the Grow/Harvest section. The Spiral Tower supplies the Conveyor a quantity of seedlings necessary to maintain optimum produce production. The germination process for individual seeds in a seed tray begins at an upper entry port, traveling in a spiral stream from the upper entry port to a lower exit port where the seedlings are at the desired point in their growth for finishing the plant's growth and harvesting. In one embodiment, they are transferred to an aeroponic or other plant growing system that offer efficient growth conditions for developing into a mature plant and harvested as produce for sale.

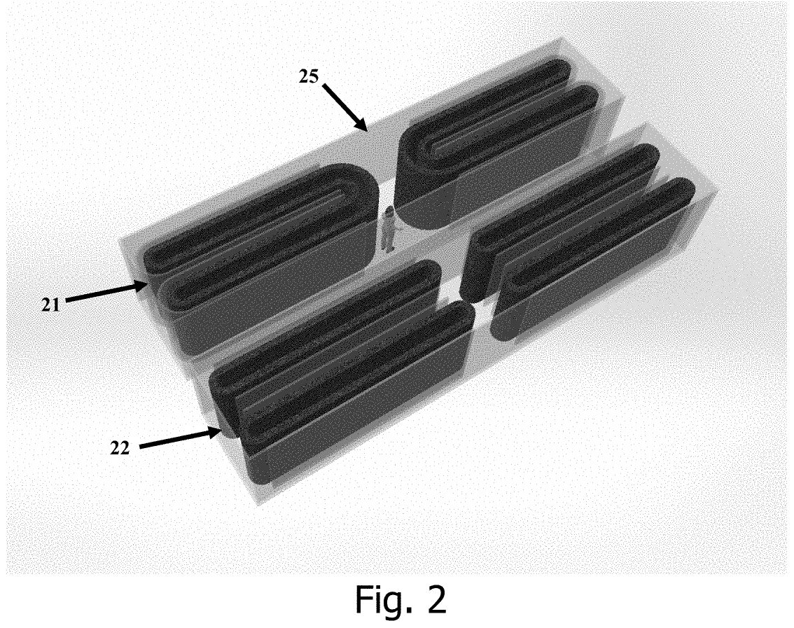

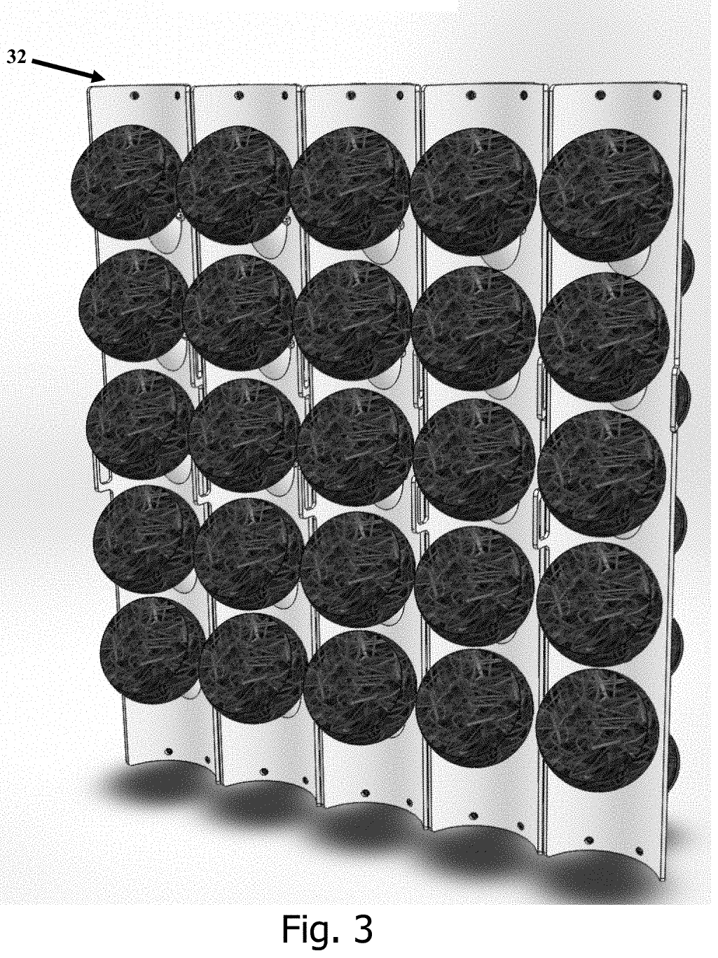

FIG. 2 depicts two different vertical Conveyor layouts in an aeroponic system, found in the Grow/Harvest section in a closed environment such as within a designated building or warehouse, 25. Grow lights are arranged to allow for maximum exposure while the conveyors are moving. FIG. 3 depicts several Wall Elements 32, which may be utilized in either a static wall, or as part of a vertical moving conveyor. These Wall Elements may be flat, curved to reflect the light, or be other complex geometry to facilitate light diffusion, plant angle and layout, and other requirements determined to enhance plant growth and planting density. FIG. 3 depicts a Wall where the individual Wall Elements may be narrowed to accommodate young seedlings and then expanded as the plants grow larger. This allows for greater density as sections of the conveyor can be assigned plants in different stages of maturity, thus ensuring a continuous daily output. As an example, a conveyor has 200 Wall Elements, each able to support 10 plants. The plants have a 20-day growth cycle. Then to provide continuous output 10 Wall elements would have plants 1 day old, 10 Wall Elements would have plants 2 days old, etc. This arrangement would yield 100 mature plants each day continuously. This would also require that a Seed Tray or Trays be able to replace the 100 plants, and that they also be staged so that the Seed Tray or Trays are available each day. The present invention describes a means for providing the necessary seedlings to be propagated into plants to meet this demand as the Spiral Tower is juxtaposed to the Conveyor to provide the necessary 100 seedlings to replace the newly harvested plants. Typical plants can include wheatgrass, small vegetables such as leaf lettuce, cucumbers, squash, peppers, peas, etc. While all means for propagating and harvesting plants are considered, the propagating systems described herein, having conveyor(s) in an aeroponic system, is preferred for seedlings obtained from Spiral Towers.

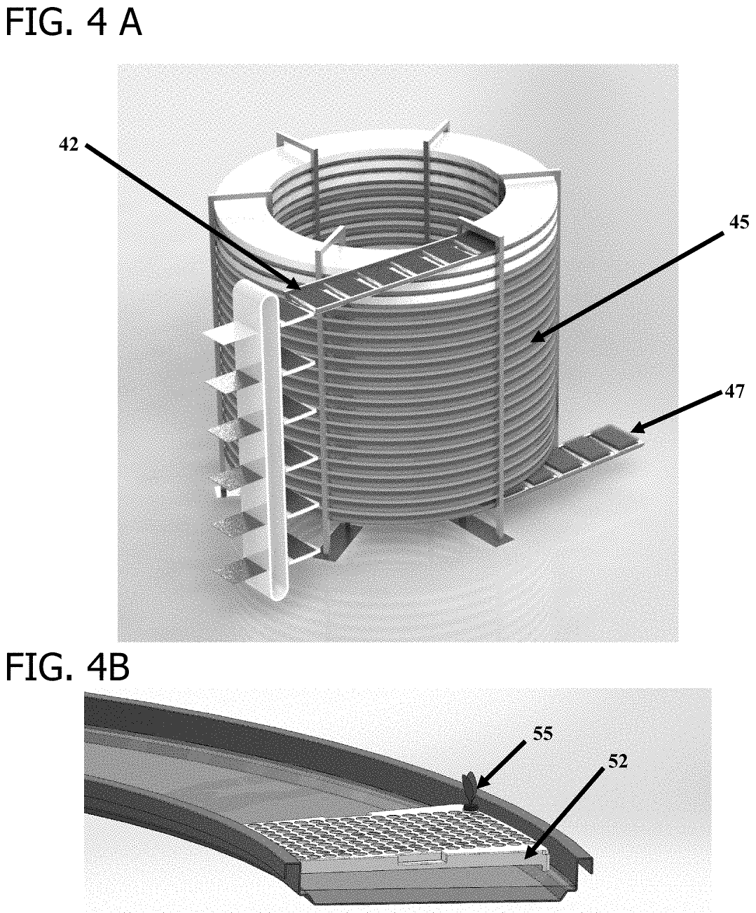

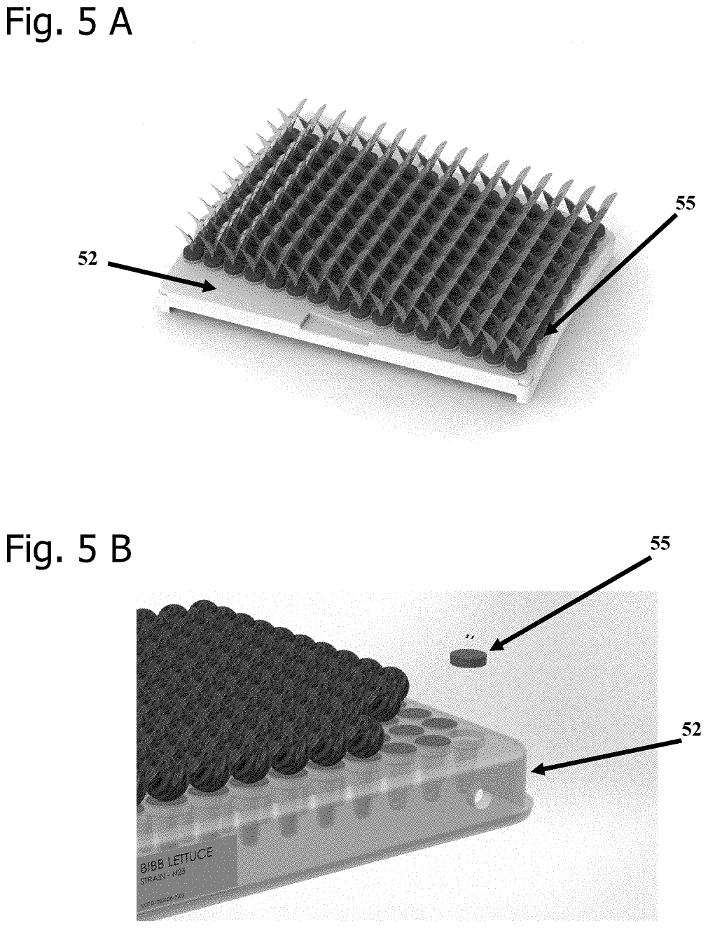

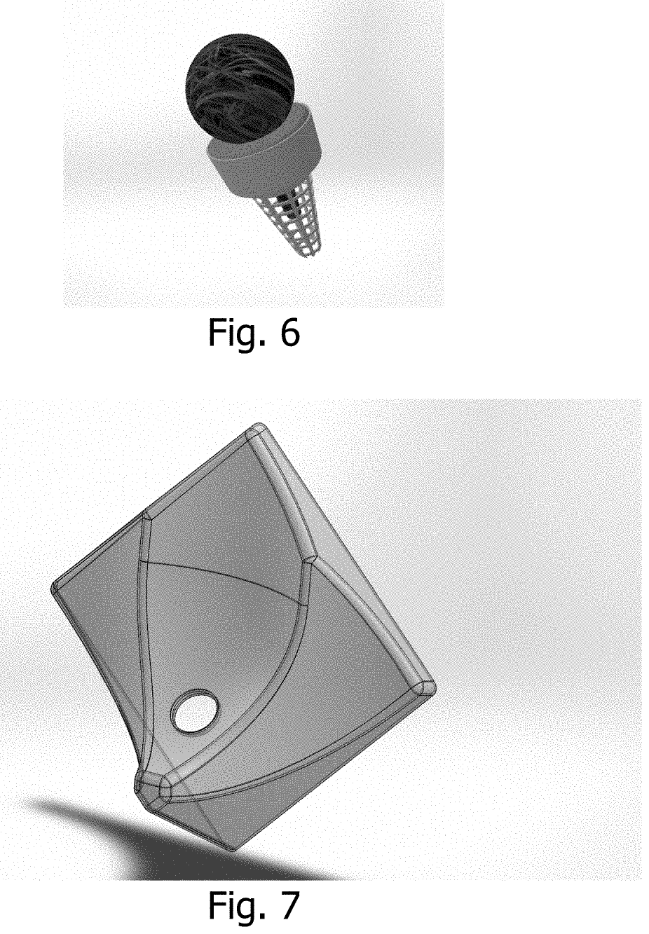

The Spiral Tower has the flexibility to function in a combination growth system with Harvest Conveyor for large production output. While in another embodiment, the Spiral Tower is suitable for use as a self-contained growth system for a controlled growth and harvest, again for use with large production requirements. The Spiral Tower itself incorporates a spiral flow design to allow the Seed Tray to move freely. The design of the Seed Tray itself is based, in part, on the spiral and is dependent upon the shape of the perimeter of the Seed Tray so that it covers the surface of the stream. When juxtaposed to the prior and subsequent order of Seed Trays in the stream, the orientation completely removes gaps or spaces as the Seed Trays move with the current. Other configurations are considered in the Seed Tray or Carrier Tray design such as, but not limited to, a trapezoid shape. FIG. 4 A shows a Spiral Tower with an inner view of the spiral water stream carrying the Seed Trays. Seed Trays containing the seeds are placed on the spiral stream at the entry port 42 with seeded pucks embedded into Carrier Trays. The spiral stream of nutrient containing water, 45, floats the Seed Tray along the spiral at a rate sufficient to allow the Seed Tray to reach the exit port, 47, where the seedlings have developed sufficiently on the Carrier Trays for transfer to a plant growth system. A further representation of the floating Carrier Tray is shown in FIG. 4B where the spiral stream of nutrient containing water has moved the Carrier Tray along the stream path. In this representation, only a single embedded puck is shown with a developing plant. FIG. 5A shows the Carrier Tray with the Grow Pods or Pucks , 55, in place. FIG. 5B shows the molded Seed Tray or Carrier Tray, 52, with a number of Grow Pods, 55, embedded with or without seeds. The Grow Pods are fabricated from a medium capable of allowing the roots of a seedling to penetrate it and also to retain water to germinate the seeds. For example, rock wool provides ideal root support in the Grow Pods. It can be retained in the Seed Tray using a soluble adhesive to allow it to be easily removed from the lower port of the Spiral Tower and moved to an individual holder for the Grow Pod, FIG. 6, which would then be placed into an engineered spot on a Grow Wall or Grow Tile, FIG. 7, or other holding device.

In one embodiment, the Seed Tray is inserted into an upper port or opening in the Spiral Tower and allowed to float along a spiral stream of water containing nutrients and other factors properly optimized for seed germination. The Spiral Tower with its water stream is maintained under optimum conditions for seedling germination, including temperature which is typically 68° F. When inserted into the entry port of the Spiral Tower, the Seed Tray containing Grow Pods are exposed to a supply of nutrient-infused water which by the design of the elements would moisten the Grow Pods and eventually the roots of the seedlings. These are hydroponic conditions with the water spiraling down within the Spiral Tower and having the floating Seed Trays move at a predetermined rate required for optimum growth so that when the Seed Tray reaches the lower exit port of the Spiral Tower the germinating seedlings are at a stage in development that allows for the plants to be transferred to another system for continued plant growth maturing to their eventual harvest. The other system for continued plant growth can be, but not limited to, an aeroponic system.

The Spiral Tower significantly reduces the need for individuals to consistently manipulate shelves, as currently required in Grow Modules having horizontal propagating drawers. The Spiral Tower may further contain LED light sources positioned along the spiral at the appropriate distance from each plant to ensure a controlled light source providing the appropriate amount of light needed for a growing seedling (16-17 moles per day). Accesses within the Chamber to the germinating seeds can only occur at the upper entry port or lower exit port. This closed environment removes potential human error and allows the seeds to germinate in a controlled process. The flow rate, nutrient type and other necessary components may only be altered indirectly outside the closed chamber. One situation is to alter/adjust conditions such as through an outer supply reservoir controlled through an onboard program.

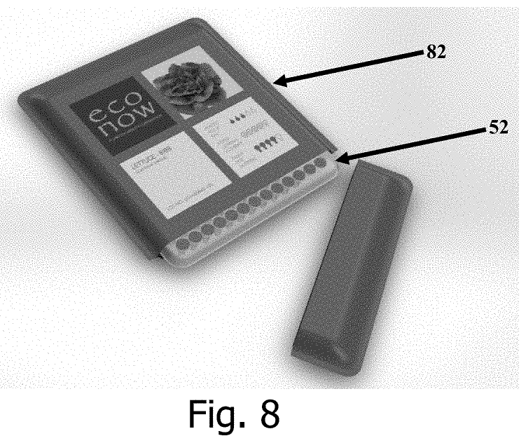

FIG. 8 shows one means for supplying the seeds for subsequent germination. The shipping bag, 82, contains the Seed Trays, 52, with seeds in place. All information concerning the seeds type and growing requirements would be printed on the bag. All Seed Trays would have a unique bar code or RFD tag or other identification readable by the system so they could only be used once, if desired.

In addition to using the Spiral Tower for germinating seeds, another embodiment of the present invention considers the Spiral Tower as a stand-alone, self-contained unit to provide continued growing conditions for small plants. All appropriate plants suitable for controlled growth in early plant life are considered. A plant seedling can be introduced at the entry port for continued growth under specific desired growth conditions. The plant is allowed to continue growing to a specified point for collection at the exit port. The Spiral Tower is especially appropriate for small plants especially susceptible to disease or where a specific growth environment is needed to provide certain plant characteristics.

For example, a few plants change their color naturally in response to pH changes in their cells. Some varieties of morning glories have flowers that start out pink as a bud, turn blue in full bloom and turn pink again as the flower wilts. The color changes occur as a result of subtle cellular pH changes over the course of a day. Hibiscus flowers can change color over the course of a day in response to cellular pH changes combined with other factors such as temperature and rainfall. Hydranges are known for changing its flower color in response to changes in soil pH. The color of Hydrangea macrophylla's blooms can be pink or blue depending on the soil pH where the hydrangea is situated. Hydrangea flowers are blue in acidic soil with a pH of 5.5 or lower. Blooms are pink if soil pH is 7 or higher. The flowers will be of a shade between pink and blue when pH is between 5.5 and 7.

A still further embodiment includes the use of the Spiral Tower in the asexual reproduction of plants. Asexual reproduction produces new individuals without the fusion of gametes, genetically identical to the parent plants and each other (i.e. clones except when mutations occur. These mutations can be caused by exposure to certain environmental factors. The Spiral Tower allows for growing conditions in an environ meat where these mutations are minimized or designed to enhance certain point mutations to obtain a desired characteristic in a flower, fruit or leaf or an entire plant.

A still further embodiment includes the production of specific plant types from germination to harvest such as, but not limited to, wheatgrass. These types of plants are rapidly growing plants with a short growth period to harvest. Wheatgrass can be grown indoors or outdoors. A common method for sprout production indoors is often on trays in a growth medium such as a potting mix. Leaves are harvested when they develop a “split” as another leaf emerges. These can then be cut off with scissors and allow a second crop of shoots to form. Sometimes a third cutting is possible, but may be tougher and have fewer sugars than the first. It has been reported that wheatgrass requires about 200 days of slow growth, through the winter and early spring. The plant reaches its peak nutritional value after concentrations of chlorophyll, protein, and vitamins decline sharply. Wheatgrass is harvested, dehydrated at a low temperature and sold in tablet and powdered concentrates for human and animal consumption. Indoor grown wheatgrass is used to make wheatgrass juice powder. The Spiral Tower allows the grower to control this process and harvest the wheatgrass when it reaches it's peak nutritional value. The production process can then be designed to reintroduce the plant after harvest into the entry port of the Spiral Tower or begin germinating a new seedling for complete growth within the device and subsequent harvest.

Finally having a tower design, the space for growing is optimized within any area, allowing the production of plants in almost any area, including urban or rural areas and regions not conducive for plant growth in a cost and space efficient manner.

Thus, the Spiral Tower of the present invention contains an improved Spiral Tower to supply developed seedlings to a plant growing portion of the system for final maturation of individual plants in a continuous supply of commercial produce. The plant growing portion has all the elements for completing the development of the plants, including a conveyor system described above, the Growth Wall elements and the misting element which is fixed to provide maximum misting to the growing roots. An emergency water tank is situated above the conveyor system for access during power outage. Situated along the outer areas of the conveyor belts, LED grow lights provide the necessary light source for finishing the plant.

Further, the Spiral Tower is a stand-alone system which has the ability to provide a complete germinating and maturation environment. The Spiral Tower is applicable for plants in the early stage of development where a controlled environment optimizes the growth conditions. The Spiral Tower is also applicable as a stand-alone growth system for providing an asexual growing environment. The Spiral Tower is further applicable for continued growing and harvest of certain plant types that generate sprouts for harvest with subsequent re-introduction for another growth cycle (i.e. wheatgrass).

In addition, the farming industry and producers has recently instituted new food safety procedures for consumers and their workers in the food industry. With the outbreak of Covid-19, the cost impact on production and safety, such as with social distancing, has required drastic changes in plant production. The Spiral Tower enables growers to safely control the exposure to workers where safe working conditions are needed and provides a means to safely increase production at a reduced cost.

What is claimed is:

1. A Spiral Tower comprising:
a. a spiral containment path having an entry port and exit port;
b. a downward spiraling sheet of water balanced for pH and nutrient levels;
c. trays containing seeds in a growth matrix moving down the spiral path.
d. A light source emitting those spectrums best suited to plant growth at a particular stage in the germination sequence for a particular species.

2. The Spiral Tower of claim 1 wherein the stream of water is pH balanced and contains nutrients for germinating a specific seed type.

3. The Spiral Tower of claim 1 wherein the Seed Tray contains seedlings ready for transplanting at the exit port.

4. The Spiral Tower of claim 1 wherein the local environment is maintained at an optimum temperature, humidity and light levels for germinating seeds.

5. The Spiral Tower of claim 1 wherein an exit port is located at the end point along the spiral

6. The Spiral Tower of claim 1 wherein the seeds are located on the seed tray in an optimum growth matrix.

7. The Spiral Tower of claim 1 wherein the seed tray has a trapezoid perimeter to limit light exposure to the roots and facilitate movement down the spiral path.

8. The Spiral Tower of claim 1 wherein flow rate, nutrient levels, and environmental factors are controlled from outside the system.

9. An Automated Grow Center comprising:
a. a Spiral Tower of claim 1 with a purpose of germinating seeds to produce robust seedlings;
b. a section dedicated to taking the seedlings to maturity and an automated system to both ,5 transplant the seedlings and harvest the mature plants at the end of their growth cycle; and
c. a self-contained enclosure/building capable of maintaining the requisite temperature, humidity and air quality necessary to maintain optimum growth conditions to include air born pathogen removal.

10. The Automated Grow Center of claim 9 where the requisite growth conditions are achieved with hydroponic and/or an aeroponic methodology.

11. The Automated Grow Center of claim 10 where the grow system is a series of vertical conveyers to expose the plants to the nutrients, environment and light necessary for optimum growth in a sequence mirroring the best conditions at several stages of growth.

12. The Automated Grow Center of claim 11 where the vertical conveyers have Spiral Towers designed to produce a continuous supply of seedlings to maintain continuous output.

13. A method for aeroponic growth of plants in a self-contained tower comprising:
a. controlling the environment within a closed spiraling conveyor;
b. introducing seedlings at a first position along the spiral;
c. optimizing conditions for seed germination; and
d. harvesting the plants at a second position along the conveyor wherein the growth within the self-contained tower provides large scale productions of plants.

14. The method of claim 13 where controlling the environment is within a closed tower having a downward moving spiral.

15. The method of claim 13 where the seedlings are planted on a carrier tray along the spiral.

16. The method of claim 13 where optimizing conditions includes water, temperature, and nutrients.

17. The method of claim 13 where harvesting at the second position allows introducing more seedlings at the first position.

18. The method of claim 13 where plants are in a group consisting of wheatgrass, flowers, small vegetables, and combinations thereof.
